(19) United States
(12) Patent Application Publication
(10) Pub. No.: US 2006/0179324 A1
(43) Pub. Date: Aug. 10, 2006

(54) Methods and apparatus for facilitating a secure session between a processor and an external device

(75) Inventor: Akiyuki Hatakeyama, Kanagawa (JP)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc., Minato-ku (JP)

(21) Appl. No.: 11/347,069

(22) Filed: Feb. 3, 2006

Related U.S. Application Data
(60) Provisional application No. 60/650,755, filed on Feb. 7, 2005.

(51) Int. Cl. G06F 12/14

(52) U.S. Cl. 713/187

(57) ABSTRACT

Methods and apparatus provide for verifying operating system software integrity prior to being executed by a processor, the processor including an associated local memory and capable of operative connection to a main memory such that data may be read from the main memory for use in the local memory; storing a status flag indicating whether the operating system software integrity is or is not satisfactory; and ensuring that the status flag indicates that the operating system software integrity is satisfactory before permitting the processor to continue in a course of action.

### CROSS REFERENCE TO RELATED APPLICATIONS

This application claims the benefit of U.S. Provisional Patent Application No. 60/650,755, filed Feb. 7, 2005, entitled “Methods And Apparatus For Facilitating A Secure Session Between A Processor And An External Device,” the entire disclosure of which is hereby incorporated by reference. This application is related to U.S. Patent Application No. 60/650,491, filed Feb. 7, 2005, entitled METHODS AND APPARATUS FOR FACILITATING A SECURE PROCESSOR FUNCTIONAL TRANSITION, the entire disclosure of which is hereby incorporated by reference.

### BACKGROUND OF THE INVENTION

The present invention relates to methods and apparatus for facilitating a secure session in which to verify the integrity of software running on a processor, such as operating system software, application software, etc.

In recent years, there has been an insatiable desire for faster computer processing data throughputs because cutting-edge computer applications are becoming more and more complex, and are placing ever increasing demands on processing systems. Graphics applications are among those that place the highest demands on a processing system because they require such vast numbers of data accesses, data computations, and data manipulations in relatively short periods of time to achieve desirable visual results. Real-time, multimedia applications also place a high demand on processing systems; indeed, they require extremely fast processing speeds, such as many thousands of megabits of data per second.

While some processing systems employ a single processor to achieve fast processing speeds, others are implemented utilizing multi-processor architectures. In multi-processor systems, a plurality of sub-processors can operate in parallel (or at least in concert) to achieve desired processing results. It has also been contemplated to employ a modular structure in a multi-processing system, where the computing modules are accessible over a broadband network (such as the Internet) and the computing modules may be shared among many users. Details regarding this modular structure may be found in U.S. Pat. No. 6,526,491, the entire disclosure of which is hereby incorporated by reference.

A problem arises, however, when a processing system is used over a network or is part of a shared resource. In particular, the processor and its associated hardware, software, data and the like are subject to outside influences such as intentional hacking, viruses and the like. Another problem involves the unauthorized or outright malicious effects that may be introduced by boot software, operating system software, application software, and content (data) that is not authenticated in some way prior to execution. Unfortunately, the conventional process of executing software applications (or other types of digital content) prescribes reading the software from a memory and executing same using a processor. Even if the processing system in which the software is executed employs some type of security feature, the software might be tampered with or may not be authorized for execution in the first place. Thus, any later invoked security measures cannot be fully trusted and may be usurped.

As the execution of application software on a processing system usually includes the use of processing resources, e.g., a disc controller (CD, DVD, etc.), graphics chips, hard disc (HD) components, tuner circuitry, network interface circuitry, etc., any problems associated with an unauthorized alteration of the operating system, application program, and/or content (e.g., via hacking or via a virus) may propagate into the processing resources of the system.

Accordingly, there are needs in the art for new methods and apparatus for providing security features in a processing system to ensure that any unauthorized alteration of the operating system, application software, and/or content may be detected and that a secure processing environment may be established to achieve a secure session with any processing resources.

### SUMMARY OF THE INVENTION

Aspects of the invention provide for authenticating operating system software, software applications and/or content within a secure processor, preferably in connection with establishing a secure session with an external device. By establishing a secure processing environment (not subject to hacking and/or viruses) and then authenticating the operating system software, software applications and/or content within the secure processor, one can assume a trusted environment in which data manipulations may take place, including secure sessions with external devices.

In accordance with one or more aspects of the present invention, it is desirable to establish a secure processing environment. This may involve triggering a state in which no externally-initiated data access request into the processor will be responded to. In other words, the secure processor will not respond to any outside request for data (e.g., a request to read contents on a local memory or registers). Thus, when the processor enters a secure mode, it creates a trusted environment in which to launch further security measures, such as authentication of software applications and content.

Preferably, trusted decryption code (and a trusted decryption key) is stored in a secure memory (e.g., a flash ROM) that is associated with a particular processor. The trusted decryption code and decryption key are preferably only available from the flash ROM when the processor has entered a secure mode. This decryption capability is preferably hardware-implemented (e.g., software that is burned into the flash ROM or any other suitable hardware device). Once the trusted decryption code is invoked, it may be used to decrypt a public key authentication program (which was encrypted using the trusted key) and stored in a system memory (outside the secure processing environment). The public key authentication program may be used to decrypt and authenticate other application programs and content.

By way of example, the public key authentication program may be operable to decrypt an operating system that has been encrypted using a trusted key (e.g., a private key of a private/public key pair). The public key authentication program running on the secure processor may use a public key (e.g., the public key of the private/public key pair) to decrypt and verify the operating system. The operating system may also be signed by an electronic signature (e.g., a hash result), which may also be verified by the public key authentication program running the hash algorithm and cross-checking the result.

When verification of the operating system is made, a verification result is stored in a secure storage area of the processor (which may be the same area used to store the pre-stored, internal public key). Thereafter, any software applications and/or content may be verified (e.g., using similar steps as to verify the OS) in the same processor or in a different processor of a multi-processor system. (If a different processor is used to verify the software applications and/or content, then it, too, is preferably in a secure mode). During this verification process, however, the processor may check the verification result stored in the secure storage area to ensure that the OS is valid and that no tampering has taken place.

It is noted that as used herein, the term “content” and “data” are broadly construed to include any type of program code, application software, system level software, any type of data, a data stream, etc.

Once the operating system and the software applications and/or content have been verified, the processor may also establish a secure session with an external device, such as a disc controller (CD, DVD, etc.), graphics chip, hard disc (HD) component, tuner circuitry, network interface circuitry, etc. This secure session may be established using another (or the same) private/public key pair to encrypt/decrypt information being passed between the processor and the external device. (Other keys may be used, such as one-time use keys, random number keys etc.) Since the OS and the software applications and/or content have been verified, the secure session is trusted.

In accordance with one or more embodiments of the present invention, methods and apparatus provide for verifying operating system software integrity prior to being executed by a processor, the processor including an associated local memory and capable of operative connection to a main memory such that data may be read from the main memory for use in the local memory; storing a status flag indicating whether the operating system software integrity is or is not satisfactory; and ensuring that the status flag indicates that the operating system software integrity is satisfactory before permitting the processor to use the data.

In accordance with one or more further embodiments of the present invention, methods and apparatus provide for: verifying operating system software integrity prior to being executed by a processor, the processor including an associated local memory and capable of operative connection to a main memory such that data may be read from the main memory for use in the local memory; storing a status flag indicating whether the operating system software integrity is or is not satisfactory; and ensuring that the status flag indicates that the operating system software integrity is satisfactory before permitting the processor to using the data or certain processing resources.

In accordance with one or more further embodiments of the present invention, methods and apparatus provide for: verifying operating system software integrity from time to time prior to and/or after being executed by a processor, the processor including an associated local memory and capable of operative connection to a main memory such that data may be read from the main memory for use in the local memory; storing a status flag indicating whether the operating system software integrity is or is not satisfactory; and ensuring from time to time that the status flag indicates that the operating system software integrity is satisfactory before permitting the processor to continue in a course of action.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a diagram illustrating a processing system in accordance with one or more aspects of the present invention;

FIG. 2 is a flow diagram illustrating processing steps that may be carried out by the processing system of FIG. 1 in accordance with one or more aspects of the present invention;

FIG. 3 is a flow diagram illustrating further process steps that may be carried out by the processing system of FIG. 1 in accordance with one or more further aspects of the present invention;

FIG. 4 is a flow diagram illustrating still further process steps that may be carried out by the processing system of FIG. 1 in accordance with one or more further aspects of the present invention;

FIG. 5 is a flow diagram illustrating still further process steps that may be carried out by the processing system of FIG. 1 in accordance with one or more further aspects of the present invention;

FIG. 6 is a flow diagram illustrating still further process steps that may be carried out by the processing system of FIG. 1 in accordance with one or more further aspects of the present invention; and

FIG. 7 is a diagram illustrating the structure of a multi-processing system having two or more sub-processors, one or more of which may include a processor having the capabilities of the processor of FIG. 1 in accordance with one or more further aspects of the present invention.

### DETAILED DESCRIPTION OF THE PRESENT INVENTION

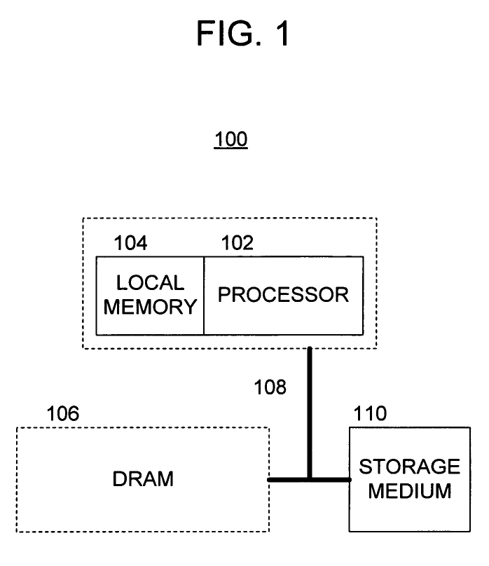

With reference to the drawings, wherein like numerals indicate like elements, there is shown in FIG. 1 a processing system 100 suitable for employing one or more aspects of the present invention. For the purposes of brevity and clarity, the block diagram of FIG. 1 will be referred to and described herein as illustrating an apparatus 100, it being understood, however, that the description may readily be applied to various aspects of a method with equal force. The apparatus 100 preferably includes a processor 102, a local memory 104, a system memory 106 (e.g., a DRAM), and a bus 108.

The processor 102 may be implemented utilizing any of the known technologies that are capable of requesting data from the system memory 106, and manipulating the data to achieve a desirable result. For example, the processor 102 may be implemented using any of the known microprocessors that are capable of executing software and/or firmware, including standard microprocessors, distributed microprocessors, etc. By way of example, the processor 102 may be a graphics processor that is capable of requesting and manipulating data, such as pixel data, including gray scale information, color information, texture data, polygonal information, video frame information, etc.

Notably, the local memory 104 is preferably located in the same chip as the processor 102; however, the local memory 104 is preferably not a hardware cache memory in that there are preferably no on chip or off chip hardware cache circuits, cache registers, cache memory controllers, etc. to implement a hardware cache memory function. In alternative embodiments, the local memory 104 may be a cache memory and/or an additional cache memory may be employed. As on chip space is often limited, the size of the local memory 104 may be much smaller than the system memory 106. The processor 102 preferably provides data access requests to copy data (which may include program data) from the system memory 106 over the bus 108 into the local memory 104 for program execution and data manipulation. The mechanism for facilitating data access may be implemented utilizing any of the known techniques, such as direct memory access (DMA) techniques.

The apparatus 100 also preferably includes a storage medium 110, such as a read only memory (ROM) that is operatively coupled to the processor 102, e.g., through the bus 108. The storage medium 110 preferably contains a trusted decryption program that is readable into the local memory 104 of the processor 102 and operable to decrypt information using a secure decryption key. Preferably, the storage medium 110 is a permanently programmable device (e.g., a flash ROM) a level of security is achieved in which the decryption program yields a trusted function and cannot be tampered with by external software manipulation. The security of the storage medium 110 is preferably such that the decryption program and/or other information (such as a trusted decryption key) may not be accessed by unauthorized entities. For example, the decryption program is preferably established and stored in the storage medium 110 during the manufacture of the apparatus 100.

It is preferred that the processor 102 and the local memory 104, are disposed on a common integrated circuit. Thus, these elements may be referred to herein as “the processor 102.” In an alternative embodiment, the storage medium 110 may also be disposed on the common integrated circuit with one or more of the other elements.

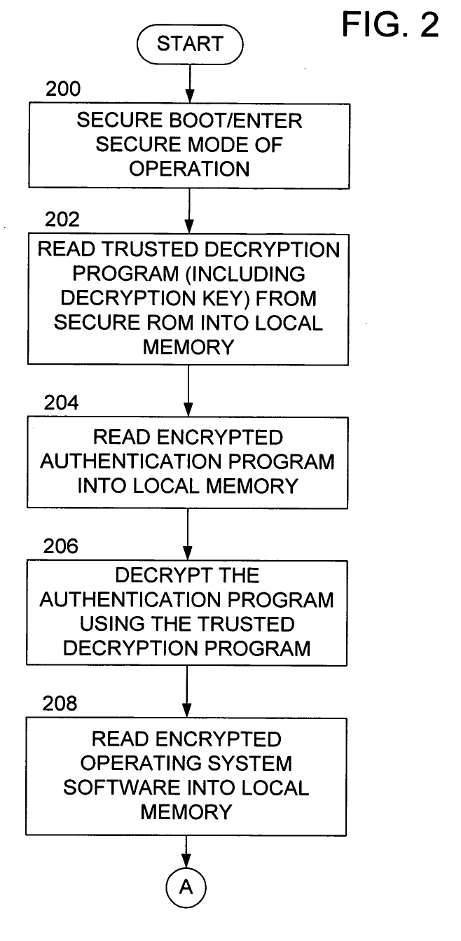

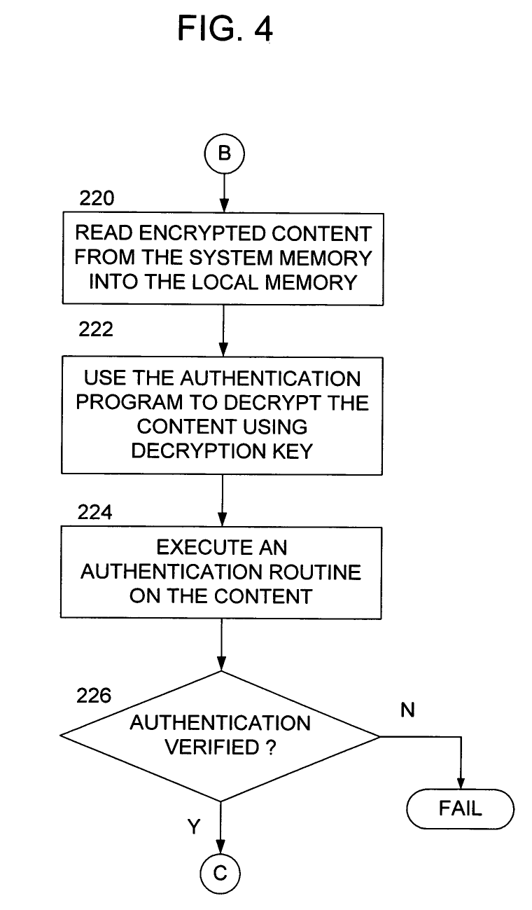

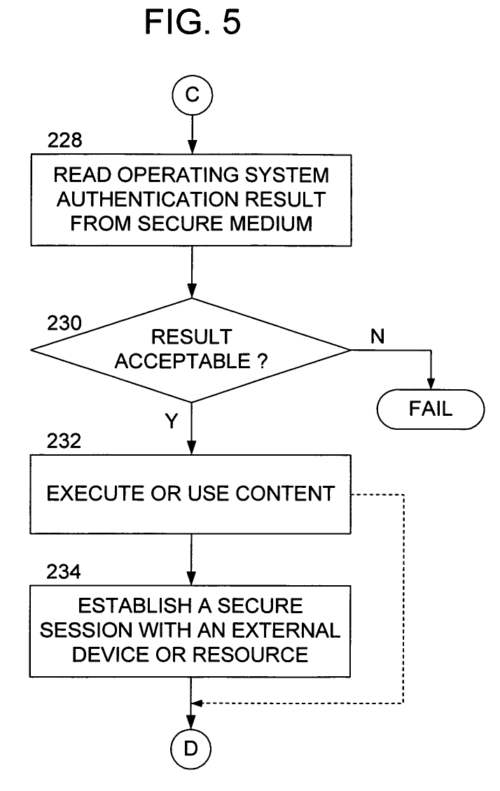

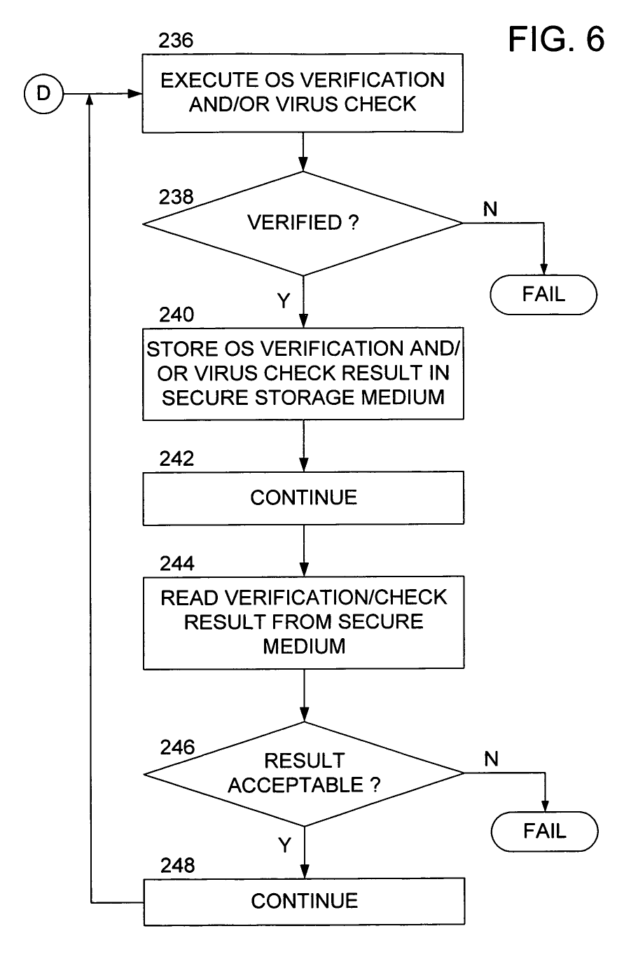

Reference is now made to the apparatus 100 of FIG. 1 and to the flow diagrams of FIGS. 2-6, which illustrate process steps that may be carried out by the apparatus 100 in accordance with one or more aspects of the present invention. At action 200, the processor 102 is preferably operable to enter a secure mode of operation. In this secure mode of operation, no requests for data stored in the local memory 104 (or any other memory devices, registers, etc.) of the processor 102 will be serviced, thereby insuring a trusted environment in which to carry out sensitive operations. Despite being in a secure mode, the processor 102 may request the transfer of data from the system memory 106 into the local memory 104, or may request the transfer of data from the local memory 104 to the system memory 106. Still further, the processor 102 may initiate the transfer of data into and out of the trusted environment irrespective of the source or destination while in the secure mode of operation.

In accordance with one or more alternative embodiments of the invention, the processor 102 may boot up in a secure fashion, whereby the boot code is first authenticated prior to permitting boot up. This ensures an even greater level of security when the processor 102 enters the secure mode of operation 200. Further details concerning the secure boot process may be found in co-pending U.S. Patent Application No.: 60/650,506, entitled METHODS AND APPARATUS FOR PROVIDING A SECURE BOOTING SEQUENCE IN A PROCESSOR, the entire disclosure of which is hereby incorporated by reference.

Once the trust environment provided by the secure mode of operation is achieved, the processor 102 is preferably operable to read the decryption program from the storage medium 110 into the local memory 104 (action 202). Preferably, a trusted decryption key is also stored within the storage medium 110 and is read into the local memory 104 for later use. At action 204, an encrypted authentication program is preferably read into the local memory 104 of the processor 102. As the authentication program is preferably encrypted, it may be stored in a less secure storage medium, such as the system memory 106. Thus, the action of reading the encrypted authentication program into the local memory 104 preferably entails obtaining the encrypted authentication program from the system memory 106.

At action 206, the encrypted authentication program is preferably decrypted using the decryption program and the trusted decryption key. This action assumes that the authentication program was encrypted utilizing a key that is associated with the trusted decryption key. As the decryption of the authentication program takes place within the trusted environment of the secure processor 102, it may be assumed that the authentication program cannot be tampered with after decryption.

In an alternative embodiment of the invention, the authenticity of the authentication program may be verified. In this regard, the step of verifying the authenticity of the authentication program may include executing a hash function on the decrypted authentication program to produce a hash result. Thereafter, the hash result may be compared with a predetermined hash value, which may be a digital signature or the like. By way of example, the hash function may be executed on the authentication program by a trusted entity to produce the predetermined hash value. The predetermined hash value may be encrypted with the authentication program itself and provided by the trusted entity to the system memory 106. Those skilled in the art will appreciate that one or more intervening entities may be employed to complete the transmission of the encrypted authentication program from the trusted entity to the system memory 106.

As discussed above, the decryption program is preferably established and stored in the storage medium 110 during manufacture of the apparatus 100. Thus, the decryption program may include the ability to execute the same hash function that was used by the trusted entity to produce the predetermined hash value. The decryption program may be operable to execute the hash function on the authentication program to produce the hash result and to compare the hash result with the predetermined hash value. If the hash result and the predetermined hash value match, then it may be assumed that the authentication program has not been tampered with and is authentic.

At action 208, once the authentication program has been invoked and/or verified, encrypted operating system software is preferably read into the local memory 104 of the processor 102. As the operating system software is encrypted, it may be stored in a relatively un-secure location, such as the system memory 106. It is preferred that the operating system software has been encrypted using a private key of a private/public key pair. Thus, no unauthorized entity can decrypt the operating system software without having the public key of the pair. At action 210, the authentication program is preferably privy to the public key of the private/public key pair and is operable to decrypt the encrypted operating system software using such key.

At action 212, an authentication routine is preferably executed on the decrypted operating system software. The authentication routine preferably verifies the authenticity of the operating system software, such as to determine whether it has been tampered with by way of hacking, whether it has been compromised by a virus, etc. This verification may be conducted prior to, or periodically during, its execution by the processor 102. In this regard, the step of verifying the authenticity of the operating system software may include executing a hash function on the decrypted operating system software to produce a hash result. Thereafter, the hash result may be compared with a predetermined hash value, which may be a digital signature or the like. By way of example, the hash function may be executed on the operating system software by a trusted entity to produce the predetermined hash value. The predetermined hash value may be encrypted with the operating system software itself and provided by the trusted entity to the system memory 106. Again, those skilled in the art will appreciate that one or more intervening entities may be employed to complete the transmission of the encrypted operating system software from the trusted entity to the system memory 106.

The authentication program may include the ability to execute the same hash function that was used by the trusted entity to produce the predetermined hash value for the operating system software. The authentication program may be operable to execute the hash function on the operating system software to produce the hash result and to compare the hash result with the predetermined hash value. If the hash result and the predetermined hash value match, then it may be assumed that the operating system software has not been tampered with and is authentic.

At action 214, the process flow may branch in response to the determination of whether the operating system software is authentic. If the result of the determination is negative, then the process flow preferably advances to a failed state where appropriate actions are taken. For example, the authentication process may be retried, a message may be delivered to an operator of the apparatus 100 indicating the failure to authenticate the operating system software, or other such actions may be taken. If the result of the determination at action 214 is in the affirmative, then the process flow preferably advances to action 216, where an indication (such as a status flag, etc.) that the operating system software was verified is stored in the storage medium 110. (Usage of this indication will be discussed later in this description.) At action 218, the processor 102 is preferably operable to invoke the operating system software.

Once the operating system software is running on the processor 102, encrypted content is preferably read into the local memory 104 of the processor 102 (action 220). As the content is encrypted, it may be stored in a relatively un-secure location, such as the system memory 106. As with the operating system software, it is preferred that the content has been encrypted using a private key of a private/public key pair. Thus, no unauthorized entity can decrypt the content without having the public key of the pair. At action 222, the authentication program is preferably privy to the public key of the private/public key pair and is operable to decrypt the encrypted content using such key.

At action 224, an authentication routine is preferably executed on the decrypted content. The authentication routine preferably verifies the authenticity of the content prior to its execution by the processor 102. In this regard, the step of verifying the authenticity of the content may include executing a hash function on the decrypted content to produce a hash result. Thereafter, the hash result may be compared with a predetermined hash value, which may be a digital signature or the like. By way of example, the hash function may be executed on the content by a trusted entity to produce the predetermined hash value. The predetermined hash value may be encrypted with the content itself and provided by the trusted entity to the system memory 106. Again, those skilled in the art will appreciate that one or more intervening entities may be employed to complete the transmission of the encrypted content from the trusted entity to the system memory 106.

The authentication program may include the ability to execute the same hash function that was used by the trusted entity to produce the predetermined hash value for the content. The authentication program may be operable to execute the hash function on the content to produce the hash result and to compare the hash result with the predetermined hash value. If the hash result and the predetermined hash value match, then it may be assumed that the content has not been tampered with and is authentic.

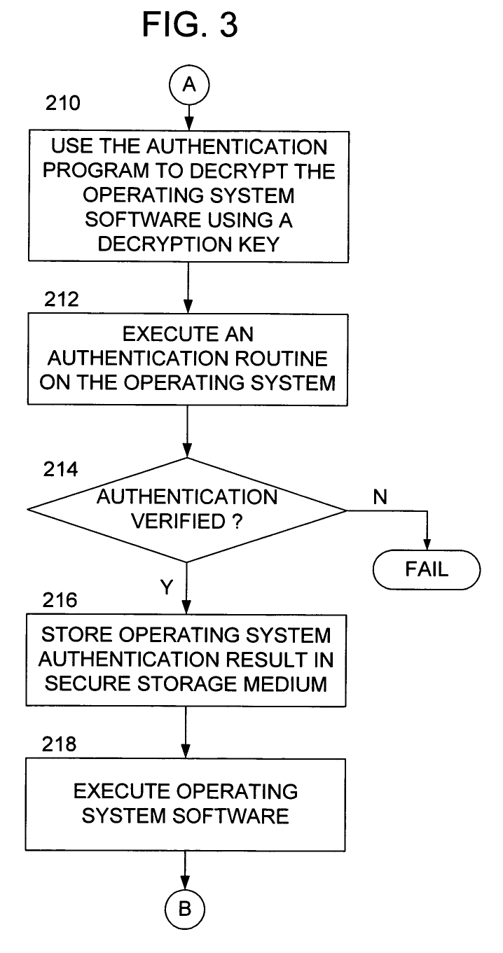

At action 226, the process flow may branch in response to the determination as to whether the content is authentic. If the result of the determination is negative, then the process flow preferably advances to a failed state where appropriate actions are taken. For example, the authentication process may be retried, a message may be delivered to an operator of the apparatus 100 indicating the failure to authenticate the content, or other such actions may be taken. If the result of the determination at action 226 is in the affirmative, then the process flow preferably advances to action 228, where the processor 102 preferably reads the operating system software authentication result from the storage medium 110. (Recall that this result was written into the storage medium 110 at action 216, FIG. 3 and indicates whether the operating system software was verified as being authentic, substantially secure and/or problem free.)

At action 230, a determination is preferably made as to whether the OS authentication result indicates that the OS is verified. If the result of the determination is negative, then the process flow preferably advances to a failed state where appropriate actions are taken. If the result of the determination at action 230 is in the affirmative, then the process flow preferably advances to action 232, where the processor 102 is preferably operable to execute the content (e.g., if it is executable) or use the content (e.g., if it is non-executable data).

In accordance with one or more further aspects of the present invention, the process flow may advance to either action 234 or 236 following the use/execution of the content at action 232. At action 234, the processor 102 is preferably operable to establish a secure session with one or more processing resources. It is noted that this session is preferably established after the processor 102 ensures that the OS authentication result (or status flag) indicates that the operating system software integrity is satisfactory. As the execution of the content, such as an application program, may invoke the use of an external device, such as a disc controller (CD, DVD, etc.), graphics chip, hard disc (HD) component, tuner circuitry, network interface circuitry, etc., the secure session, which is built upon the verification of the OS integrity, may be trusted. The secure session may be established using another (or the same) private/public key pair to encrypt/decrypt information being passed between the processor 102 and the external device. It is noted, however, that other keys may be used, such as one-time use keys, random number keys etc. Further, other secure session techniques may be employed as between the processor 102 and the external device without departing from the spirit and scope of the present invention.

From time to time it may be desirable to check the integrity of the operating system software to ensure that any tampering or virus does not compromise the system and/or any secure sessions with the external devices. At action 236, the processor 102 is preferably operable to verify the integrity of the operating system software, e.g., during any idle time or by interrupting program execution. This may entail executing a substantially similar authentication routing as was carried out at action 212. For example, the verification may include executing a hash function on the operating system software to produce a hash result, which may be compared with the predetermined hash value.

At action 238, a determination is preferably made as to whether the integrity of the operating system software is satisfactory. If the result of the determination is negative, then the process flow preferably advances to a failed state where appropriate actions are taken. If the result of the determination at action 238 is in the affirmative, then the process flow preferably advances to action 240, where an updated status flag indicating that the integrity of the operating system software is satisfactory is stored in the storage medium 110.

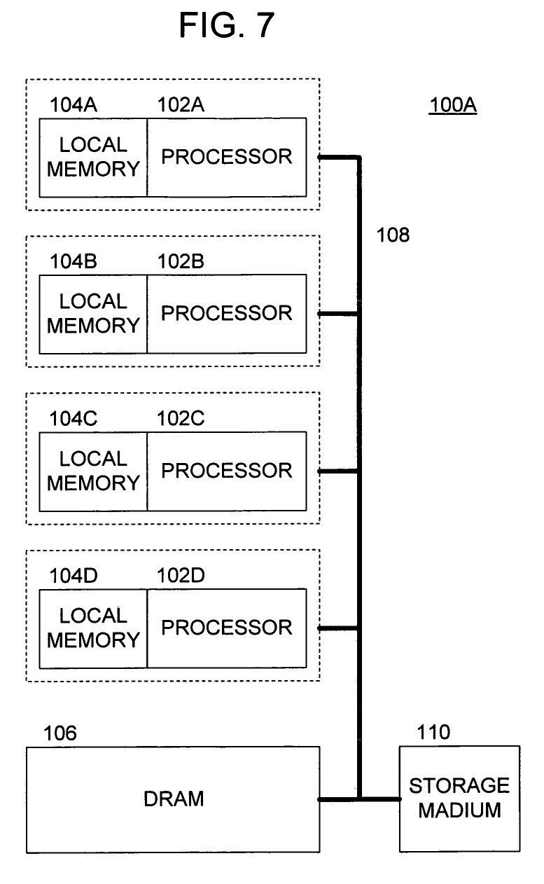

At action 242 the course of action of the processor 102 continues, e.g., the application program execution progresses, etc. At action 244, however, the processor 102 checks the status flag to ensure that the status flag indicates that the operating system software integrity is satisfactory before continuing in the course of action. In this regard, at action 246, a determination is preferably made as to whether the status flag verifies the integrity of the OS. If the result of the determination is negative, then the process flow preferably advances to a failed state where appropriate actions are taken. If the result of the determination at action 246 is in the affirmative, then the process flow Preferably advances to action 248, where the processor 102 is preferably operable to continue the course of action. It is noted that this check of the status flag is preferably required of one or more other processors (best seen in FIG. 7) that may be or become involved in the course of action. Further, the process of actions 236-248 preferably repeats from time to time to increase the efficacy of the security measures of the system.

FIG. 7 is a diagram illustrating the structure of a multi-processing system 100A having two or more sub-processors 102. The concepts discussed hereinabove with respect to FIGS. 1-6 may be applied to the multi-processing system 100A, which includes a plurality of processors 102A-D, associated local memories 104A-D, and a main memory 106 interconnected by way of a bus 108. Although four processors 102 are illustrated by way of example, any number may be utilized without departing from the spirit and scope of the present invention. The processors 102 may be implemented with any of the known technologies, and each processor may be of similar construction or of differing construction.

One or more of the processors 102 preferably includes the capabilities and elements of the processor 102 of FIG. 1. Others of the processors 102 need not include such capabilities, although it is preferred that all the processors 102 have such capabilities. In accordance with one or more further aspects of the present invention, the OS verification, authentication, integrity checks, etc. as discussed above may be performed by any number of the processors 102.

Each of the processors 102 may be of similar construction or of differing construction. The processors may be implemented utilizing any of the known technologies that are capable of requesting data from the shared (or system) memory 106, and manipulating the data to achieve a desirable result. For example, the processors 102 may be implemented using any of the known microprocessors that are capable of executing software and/or firmware, including standard microprocessors, distributed microprocessors, etc. By way of example, one or more of the processors 102 may be a graphics processor that is capable of requesting and manipulating data, such as pixel data, including gray scale information, color information, texture data, polygonal information, video frame information, etc.

One or more of the processors 102 of the system 100A may take on the role as a main (or managing) processor. The main processor may schedule and orchestrate the processing of data by the other processors.

The system memory 106 is preferably a dynamic random access memory (DRAM) coupled to the processors 102 through a memory interface circuit (not shown). Although the system memory 106 is preferably a DRAM, the memory 106 may be implemented using other means, e.g., a static random access memory (SRAM), a magnetic random access memory (MRAM), an optical memory, a holographic memory, etc.

Each processor 102 preferably includes a processor core and an associated one of the local memories 104 in which to execute programs. These components may be integrally disposed on a common semi-conductor substrate or may be separately disposed as may be desired by a designer. The processor core is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processor core may include an instruction buffer, instruction decode circuitry, dependency check circuitry, instruction issue circuitry, and execution stages.

Each local memory 104 is coupled to its associated processor core 102 via a bus and is preferably located on the same chip (same semiconductor substrate) as the processor core. The local memory 104 is preferably not a traditional hardware cache memory in that there are no on-chip or off-chip hardware cache circuits, cache registers, cache memory controllers, etc. to implement a hardware cache memory function. As on chip space is often limited, the size of the local memory may be much smaller than the shared memory 106.

The processors 102 preferably provide data access requests to copy data (which may include program data) from the system memory 106 over the bus system 108 into their respective local memories 104 for program execution and data manipulation. The mechanism for facilitating data access may be implemented utilizing any of the known techniques, for example the direct memory access (DMA) technique. This function is preferably carried out by the memory interface circuit.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
verifying operating system software integrity prior to being executed by a processor, the processor including an associated local memory and capable of being coupled to a main memory such that data may be read from the main memory for use in the local memory;
storing a status flag indicating whether the operating system software integrity is or is not satisfactory; and
ensuring that the status flag indicates that the operating system software integrity is satisfactory before permitting the processor to use the data.

2. The method of claim 1, further comprising verifying data integrity prior to checking the status flag.

3. The method of claim 1, wherein the step of verifying operating system software integrity includes:
entering a secure mode of operation where externally initiated requests to read data from or write data into the processor are not serviced but internally initiated data transfers are serviced;
reading a decryption program from a storage medium into the local memory of the processor;
reading an encrypted authentication program into the local memory of the processor;
decrypting the encrypted authentication program using the decryption program;
reading encrypted operating system software into the local memory, the operating system software having been encrypted using a private key of a private/public key pair; and
using the authentication program to authenticate the operating system software.

4. The method of claim 3, further comprising:
decrypting the encrypted operating system software using the authentication program and the public key of the private/public key pair;
verifying the integrity of the operating system software by executing a hash function thereon to produce a hash result and comparing the hash result with a predetermined hash value; and
permitting the processor to run the operating system software if the hash result matches the predetermined hash value.

5. The method of claim 4, further comprising verifying data integrity prior to checking the status flag.

6. The method of claim 5, wherein the step of verifying the data integrity includes:
reading an encrypted version of the data into the local memory, the data having been encrypted using a private key of a private/public key pair; and
using the authentication program to authenticate the data.

7. The method of claim 6, further comprising:
decrypting the encrypted data using the authentication program and the public key of the private/public key pair;
verifying the integrity of the data by executing a hash function thereon to produce a hash result and comparing the hash result with a predetermined hash value; and
permitting the processor to use the data if the hash result matches the predetermined hash value.

8. The method of claim 1, further comprising:
checking the status flag as part of a course of action in another processor, the processors being part of a multi-processor system; and
permitting the other processor to continue in the course of action only after ensuring that the status flag indicates that the operating system software integrity is satisfactory.

9. The method of claim 1, further comprising:
verifying the integrity of the operating system software from time to time and updating the status flag; and
checking the status flag from time to time to ensure that the status flag indicates that the operating system software integrity is satisfactory before permitting the processor to continue in a course of action.

10. A method, comprising:
verifying operating system software integrity prior to being executed by a processor, the processor including an associated local memory and capable of operative connection to a main memory such that data may be read from the main memory for use in the local memory;
storing a status flag indicating whether the operating system software integrity is or is not satisfactory; and
ensuring that the status flag indicates that the operating system software integrity is satisfactory before permitting the processor to using the data or certain processing resources.

11. The method of claim 10, wherein at least one of:
the processing resources include a non-volatile memory sub-system, and one or more functional circuits;
the non-volatile memory sub-system includes at least portions of software and/or hardware components of an electromagnetic memory medium, an electronic memory medium, a silicon memory medium, an optical memory medium, a hard disc memory medium, an a CD-ROM memory medium, a DVD-ROM memory medium, and an external memory medium; and
the one or more functional circuits of the apparatus includes at least one graphics processing circuit, a network interface circuit, a display interface circuit, a printer interface circuit, and a local data input and/or output interface.

12. The method of claim 10, further comprising establishing a secure session between the processor and one or more processing resources after ensuring that the status flag indicates that the operating system software integrity is satisfactory.

13. The method of claim 12, wherein the secure session between the processor and the one or more processing resources includes encrypting data shared therebetween using a pair of keys.

14. The method of claim 10, further comprising verifying integrity of the data prior to checking the status flag and permitting the processor to continue in a course of action only after the integrity of the data are ensured and the status flag indicates that the operating system software integrity is satisfactory.

15. A method, comprising:
verifying operating system software integrity from time to time prior to and/or after being executed by a processor, the processor including an associated local memory and capable of operative connection to a main memory such that data may be read from the main memory for use in the local memory;
storing a status flag indicating whether the operating system software integrity is or is not satisfactory; and
ensuring from time to time that the status flag indicates that the operating system software integrity is satisfactory before permitting the processor to continue in a course of action.

16. An apparatus, comprising:
at least one processor and associated local memory that are capable of being coupled to a main memory and being operable to request at least some data from the main memory for use in the local memory; and
a storage medium containing a decryption program,
wherein the processor is operable to:
verify operating system software integrity prior to being executed by the processor;
store a status flag indicating whether the operating system software integrity is or is not satisfactory; and
ensure that the status flag indicates that the operating system software integrity is satisfactory before using the data.

17. The apparatus of claim 16, wherein the processor is further operable to verify data integrity prior to checking the status flag.

18. The apparatus of claim 16, wherein the processor is further operable to verify the operating system software integrity by:
entering a secure mode of operation where externally initiated requests to read data from or write data into the processor are not serviced but internally initiated data transfers are serviced;
reading a decryption program from a storage medium into the local memory of the processor;
reading an encrypted authentication program into the local memory of the processor;
decrypting the encrypted authentication program using the decryption program;
reading encrypted operating system software into the local memory, the operating system software having been encrypted using a private key of a private/public key pair; and
using the authentication program to authenticate the operating system software.

19. The apparatus of claim 18, wherein the processor is further operable to:
decrypt the encrypted operating system software using the authentication program and the public key of the private/public key pair;
verify the integrity of the operating system software by executing a hash function thereon to produce a hash result and comparing the hash result with a predetermined hash value; and
run the operating system software if the hash result matches the predetermined hash value.

20. The apparatus of claim 19, wherein the processor is further operable to verify data integrity prior to checking the status flag.

21. The apparatus of claim 20, wherein the processor is further operable to verify the data integrity by:
reading an encrypted version of the data into the local memory, the data having been encrypted using a private key of a private/public key pair; and
using the authentication program to authenticate the data.

22. The apparatus of claim 21, wherein the processor is further operable to:
decrypt the encrypted data using the authentication program and the public key of the private/public key pair;
verify the integrity of the data by executing a hash function thereon to produce a hash result and comparing the hash result with a predetermined hash value; and
permit the processor to use the data if the hash result matches the predetermined hash value.

23. The apparatus of claim 16, wherein the processor is further operable to:
verify the integrity of the operating system software from time to time and update the status flag; and
check the status flag from time to time to ensure that the status flag indicates that the operating system software integrity is satisfactory before continuing in a course of action.

24. The apparatus of claim 16, wherein:
any of a plurality of such processors in a multi-processor system are operable to:
check the status flag as part of a course of action; and
continue in the course of action only after ensuring that the status flag indicates that the operating system software integrity is satisfactory.

25. An apparatus, comprising:
at least one processor and associated local memory capable of being operatively coupled to a main memory and being operable to request at least some data from the main memory for use in the local memory; and
a storage medium containing a decryption program,
wherein the processor is operable to:
verify operating system software integrity prior to being executed;
store a status flag indicating whether the operating system software integrity is or is not satisfactory; and
ensure that the status flag indicates that the operating system software integrity is satisfactory before using the data or certain processing resources.

26. The apparatus of claim 25, wherein at least one of:
the processing resources include a non-volatile memory sub-system, and one or more functional circuits;
the non-volatile memory sub-system includes at least portions of software and/or hardware components of an electromagnetic memory medium, an electronic memory medium, a silicon memory medium, an optical memory medium, a hard disc memory medium, an a CD-ROM memory medium, a DVD-ROM memory medium, and an external memory medium; and
the one or more functional circuits of the apparatus includes at least one graphics processing circuit, a network interface circuit, a display interface circuit, a printer interface circuit, and a local data input and/or output interface.

27. The apparatus of claim 25, wherein the processor is further operable to establish a secure session with one or more processing resources after ensuring that the status flag indicates that the operating system software integrity is satisfactory.

28. The apparatus of claim 27, wherein the secure session between the processor and the one or more processing resources includes encrypting data shared therebetween using a pair of keys.

29. The apparatus of claim 25, wherein the processor is further operable to verify integrity of the data prior to checking the status flag and continuing in a course of action only after the integrity of the data are ensured and the status flag indicates that the operating system software integrity is satisfactory.

30. A storage medium containing a software program that is capable of causing a processor to execute actions, comprising:
verifying operating system software integrity prior to being executed by the processor, the processor including an associated local memory and being capable of operative connection to a main memory such that data may be read from the main memory for use in the local memory;
storing a status flag indicating whether the operating system software integrity is or is not satisfactory; and
ensuring that the status flag indicates that the operating system software integrity is satisfactory before permitting the processor to use the data.

31. A storage medium containing a software program that is capable of causing a processor to execute actions, comprising:
verifying operating system software integrity prior to being executed by the processor, the processor including an associated local memory and capable of operative connection to a main memory such that data may be read from the main memory for use in the local memory;
storing a status flag indicating whether the operating system software integrity is or is not satisfactory; and
ensuring that the status flag indicates that the operating system software integrity is satisfactory before permitting the processor to using the data or certain processing resources.

32. A storage medium containing a software program that is capable of causing a processor to execute actions, comprising:
verifying operating system software integrity from time to time prior to and/or after being executed by the processor, the processor including an associated local memory and capable of operative connection to a main memory such that data may be read from the main memory for use in the local memory;
storing a status flag indicating whether the operating system software integrity is or is not satisfactory; and
ensuring from time to time that the status flag indicates that the operating system software integrity is satisfactory before permitting the processor to continue in a course of action.
